(19) United States
(12) Patent Application Publication
(10) Pub. No.: US 2017/0057856 A1
(43) Pub. Date: Mar. 2, 2017

(54) Method for Producing Optical Element and Optical Element

(71) Applicant: Konica Minolta, Inc., Tokyo (JP)

(72) Inventors: Shuhei Ashida, Hino-shi, Tokyo (JP); Shuhei Hayakawa, Hachioji-shi, Tokyo (JP)

(73) Assignee: Konica Minolta, Inc., Tokyo (JP)

(21) Appl. No.: 15/119,642

(22) PCT Filed: Feb. 19, 2015
(86) PCT No.: PCT/JP2015/054554

§ 371 Date: Aug. 17, 2016

(30) Foreign Application Priority Data
Feb. 20, 2014 (JP) 2014-030882

(51) Int. Cl. C03B 11/12; C03B 11/08

(52) U.S. Cl. CPC C03B 11/122; C03B 11/084; C03B 2201/86; C03B 2215/46; C03B 2215/66; C03B 2215/76

(57) ABSTRACT

Provided is a method for producing an inexpensive chalcogenide optical element having high performance. An inside of chalcogenide glass is also heated uniformly by heating the chalcogenide glass with an infrared ray (light LI). Therefore, a molded lens LE hardly causes a crack or the like, a work piece WP as a block of the chalcogenide glass can be softened in a short time, and time required for molding can be shortened. In addition, direct heating with an infrared ray (light LI) allows heating and cooling to be performed in a short time. Therefore, an effect of volatilization, oxidation, crystallization, or the like can be reduced, and the lens LE having a high transmittance can be molded. Press molding can be performed while the temperature of the second mold die 12 is lower than that of the glass. Therefore, the lens LE hardly causing fusion and having an excellent appearance can be molded with a low maintenance frequency.

### BACKGROUND OF THE INVENTION

Technical Field

The present invention relates to a method for producing a chalcogenide glass optical element such as a chalcogenide glass lens and an optical element obtained thereby.

Background Art

As a lens for a night vision camera or a far infrared camera used as thermography, a lens formed of chalcogenide glass is known. A composition of chalcogenide glass is for example, Ge—Se—Sb or As—Se. Such a chalcogenide glass lens requires a high transmittance due to difficulty in enhancing a sensitivity of an infrared sensor.

Chalcogenide glass for an infrared optical system has a property largely different from a normal glass material, and production of a chalcogenide glass lens has the following problems.

First, when chalcogenide glass is heated to a high temperature, a component such as Se is volatilized, a composition thereof is changed, and therefore a transmittance thereof tends to be reduced disadvantageously. Therefore, it is not desirable to keep a state of being heated to a melting temperature for a long time when chalcogenide glass is molded.

In addition, when chalcogenide glass is heated in the atmosphere, chalcogenide glass is oxidized to reduce a transmittance thereof disadvantageously. Therefore, it is not desirable to heat chalcogenide glass in the atmosphere, and it is desirable to heat and mold chalcogenide glass in an inert gas (for example, nitrogen) atmosphere.

Furthermore, chalcogenide glass has a low crystallization temperature, is easily crystallized under a press environment, and has a large progression rate of crystallization disadvantageously. That is, a temperature range in which chalcogenide glass can be molded is narrow.

In addition, due to a low thermal conductivity and a large thermal expansion coefficient, chalcogenide glass is weak against a thermal shock, and is easily cracked disadvantageously. Therefore, when reheat-molding in which a preform of chalcogenide glass is prepared in advance and the preform is reheated for molding is utilized, it is necessary to reduce a temperature rising rate or a temperature lowering rate. In addition, due to the large thermal expansion coefficient, chalcogenide glass causes a sink mark easily during molding, and a range of a heating temperature capable of generating a surface accuracy is narrow.

As described above, in order to produce a chalcogenide glass optical element, various requirements need to be satisfied, a production process becomes special, and therefore a simpler production method has been demanded. A raw material for forming chalcogenide glass is expensive, and it is also required to reduce a material discarded in a production process.

Patent Literature 1 has proposed a method for producing a lens by reheat-molding of chalcogenide glass. Specifically, chalcogenide glass is subjected to hot press molding by holding the temperature of a mold die at a temperature equal to or higher than a glass yield point of chalcogenide glass and equal to or lower than a softening point thereof However, in such reheat-molding, a glass material is heated to a molding temperature mainly by heat transfer from a mold die, but chalcogenide glass has a low thermal conductivity and a large thermal expansion coefficient, and therefore is weak against a thermal shock, and is easily cracked by rapid heating. Therefore, it takes time to raise or lower the temperature, molding cycle time is long, and cost is high disadvantageously. In reheat-molding, in order to prevent fusion, molding is performed at a temperature equal to or higher than a glass yield point and equal to or lower than a softening point. However, a scratch and roughness on a surface of a preform remain in this temperature range disadvantageously. In order to eliminate a scratch or the like on a surface of a preform, it is necessary to produce a preform of a mirror surface in a previous step such as polishing, and it takes time to manufacture an optical element disadvantageously. In addition to expensiveness of a material itself, a material is discarded by processing of a preform. Therefore, production cost is increased. In addition, chalcogenide glass is soft and is scratched easily, and therefore a yield in preform processing is poor. As described above, the production method described in Patent Literature 1 has various problems such as generation of a crack in glass, long production time, or high production cost.

Patent Literature 2 below has proposed irradiation with an infrared ray for heating a mold die. Patent Literature 2 does not describe use of chalcogenide glass. However, if chalcogenide glass is used, the temperature of a mold die becomes high to easily cause a problem of fusion between a mold lens and the mold die or reduction in a transmittance because the mold die is heated with an infrared ray which has passed through the glass.

### CITATION LIST

### Patent Literature

Patent Literature 1: JP 05-4824 A

Patent Literature 2: JP 05-186230 A

### SUMMARY OF INVENTION

### Technical Problem

The present invention has been achieved in view of the above problems, and an object thereof is to provide a method for producing an optical element capable of producing a chalcogenide optical element having high performance inexpensively and efficiently.

Another object of the present invention is to provide an optical element produced by the above production method.

In order to achieve the above objects, a method for producing an optical element according to the present invention includes softening chalcogenide glass by heating the chalcogenide glass by irradiating the chalcogenide glass with light including an infrared ray, and subjecting the softened chalcogenide glass to press molding with a mold die at a lower temperature than that of the chalcogenide glass.

According to the above method for producing an optical element, by heating chalcogenide glass with an infrared ray, an inside of the chalcogenide glass can be also heated uniformly. Therefore, a molded optical element hardly causes a crack or the like, a block of the chalcogenide glass can be softened in a short time, and time required for molding can be shortened. In addition, direct heating with an infrared ray allows heating and cooling to be performed in a short time. Therefore, an effect of volatilization, oxidation, crystallization, or the like can be reduced, and an optical element having a high transmittance can be molded. Press molding is performed while the temperature of the mold die is lower than that of the glass. Therefore, an optical element hardly causing fusion and having an excellent appearance can be molded with a low maintenance frequency. The temperature of the glass is controlled separately from that of the mold die. Therefore, an optical element having a higher surface accuracy or shape accuracy can be produced.

The optical element according to the present invention is produced by the above method for producing an optical element.

### BRIEF DESCRIPTION OF DRAWINGS

FIG. 1 is a schematic diagram describing a production device for performing a method for producing an optical element according to a first embodiment.

FIGS. 2A to 2C are diagrams describing the method for producing an optical element.

FIG. 3 is a diagram describing change in a temperature of glass during molding.

FIGS. 4A to 4C are diagrams describing the method for producing an optical element.

FIGS. 5A to 5C are diagrams describing a method for producing an optical element according to a second embodiment.

FIGS. 6A and 6B are diagrams describing the method for producing an optical element according to the second embodiment.

### DESCRIPTION OF EMBODIMENTS

### First Embodiment

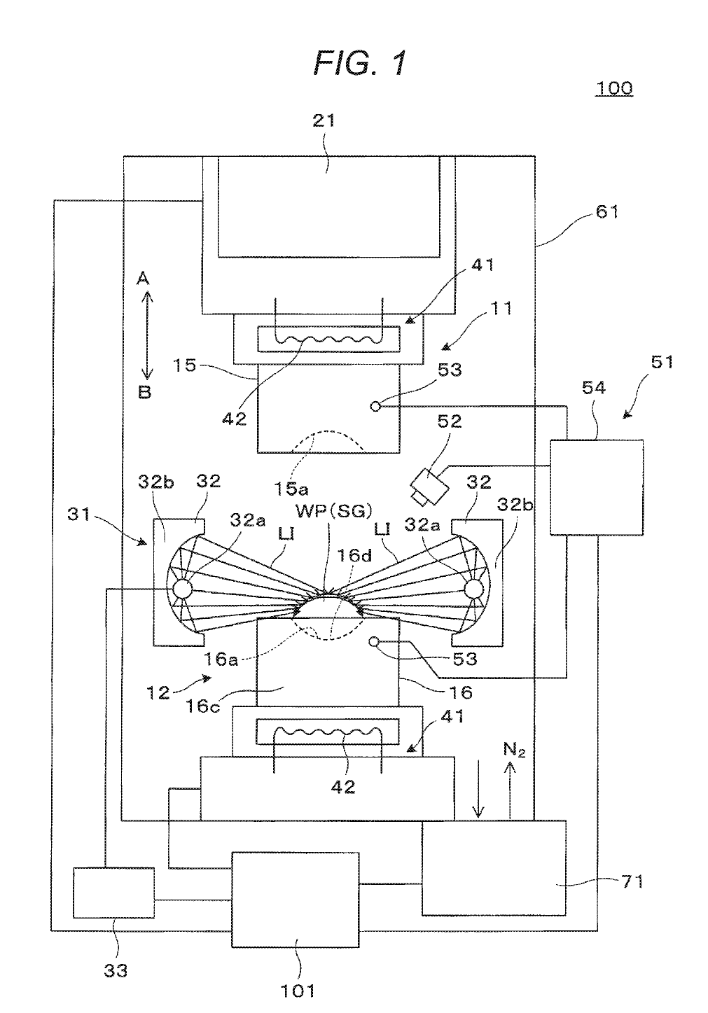

As illustrated in FIG. 1, a production device 100 for performing a production method according to a first embodiment includes a pair of upper and lower mold dies 11 and 12, a mold die driving unit 21 for the upper mold die 11, a first heating unit 31 for heating a work piece WP of chalcogenide glass mounted on the lower mold die 12, a second heating unit 41 for heating the mold dies 11 and 12, a temperature monitoring unit 51 for monitoring the temperature of the work piece WP on the mold die 12 or the like, a chamber 61 for accommodating the mold dies 11 and 12 or the like, an atmosphere adjustment unit 71 for adjusting the atmosphere in the chamber 61, and a main control unit 101 for controlling the units of the device.

The upper first mold die 11 includes a transfer member 15 provided with a transfer surface 15a. The work piece WP becomes a heated softened glass body SG as described below, and the transfer member 15 transfers a first optical surface to an upper side of the softened glass body SG with the transfer surface 15a. The transfer surface 15a illustrated in the figures is a concave mirror surface, but the transfer surface 15a may be a convex surface or a plane surface without being limited to the concave surface. The transfer surface 15a can be a non-smooth surface such as a rough surface or a step surface without being limited to a spherical surface, an aspherical surface, or a free curved surface. The transfer member 15 is formed of metal, ceramic, a composite member, or the like, and is specifically formed, for example, of a material having a low thermal conductivity, such as metal zirconium or glassy carbon.

The lower second mold die 12 includes a transfer member 16 provided with a transfer surface 16a. The transfer member 16 transfers a second optical surface to a lower side of the softened glass body SG with the transfer surface 16a. The transfer surface 16a illustrated in the figures is a concave mirror surface, but the transfer surface 16a may be a convex surface or a plane surface without being limited to the concave surface. The transfer surface 16a can be a non-smooth surface such as a rough surface or a step surface without being limited to a spherical surface, an aspherical surface, or a free curved surface. The transfer member 16 is formed of metal, ceramic, a composite member, or the like, and is specifically formed of a material having a low thermal conductivity, a material having a thermal conductivity preferably of 20 W/mK or less, more preferably of 10 W/mK or less. For example, the transfer member 16 is preferably formed of a material having a low thermal conductivity, such as metal zirconium or glassy carbon. Heating chalcogenide glass by irradiating the chalcogenide glass with light on a member or a layered body formed of a material having a low thermal conductivity prevents heat from being taken away from the chalcogenide glass during heating, and allows the chalcogenide glass to be heated uniformly in a short time. A main body 16c of the transfer member 16 is covered with a surface layer 16d, and the surface layer 16d forms the transfer surface 16a. The surface layer 16d is formed of a material having a lower emissivity than the main body 16c (for example, a material having an emissivity of 0.3 or less), and is specifically formed of a material having a metallic luster. This can prevent the second mold die 12 from being heated by an infrared ray from the first heating unit 31, and can make control of the temperature of the second mold die 12 easy. In the surface layer 16d, a film for preventing fusion, for example, a diamond-like carbon film can be provided on a layer having a low emissivity. The diamond-like carbon substantially transmits an infrared ray, and therefore is not heated by irradiation with an infrared ray.

The mold die driving unit 21 can raise or lower the first mold die 11 in an up-down AB direction (vertical direction) at a desired timing. By lowering the first mold die 11, clamping for pressing the first mold die 11 with respect to the second mold die 12 at a desired pressure is possible. The mold die driving unit 21 can align the first mold die 11 with respect to the second mold die 12 by slightly moving the first mold die 11 in a lateral direction perpendicular to the AB direction.

The first heating unit 31 includes an infrared ray irradiation unit 32 and a heating driving unit 33. The infrared ray irradiation unit 32 includes an infrared lamp 32a and a mirror 32b. The infrared lamp 32a heats a preheated work piece WP with a heat ray to soften the work piece WP. Light LI radiated from the infrared lamp 32a for heating (hereinafter, also referred to as infrared ray) includes preferably an infrared ray absorbed moderately by chalcogenide glass, more preferably light having an energy distribution in a wavelength of 0.5 to 2 μm. As the infrared lamp 32a, it is more preferable to use a lamp having an energy in a wavelength range of a light absorption edge of chalcogenide glass to be heated and molded ±0.5 μm. The wavelength of the light absorption edge depends on a composition of chalcogenide glass, and therefore a lamp according to the composition is preferably selected. In this way, use of an infrared ray having a wavelength absorbed moderately by chalcogenide glass allows an object to be heated uniformly. For example, the infrared lamp 32a is formed of a halogen lamp. The mirror 32b reflects the light LI including an infrared ray for heating, emitted from the infrared lamp 32a toward the workpiece WP. The number of the infrared ray irradiation unit 32 is not limited to one. A plurality of the infrared ray irradiation units 32 can be disposed around an upper portion of the lower second mold die 12. The infrared ray irradiation unit 32 is preferably disposed such that the light LI including an infrared ray for heating is not strongly incident on the second mold die 12 outside the work piece WP or the like. Therefore, in the present embodiment, the infrared ray irradiation unit 32 is disposed such that light is emitted from a side of the work piece WP. The heating driving unit 33 makes the infrared ray irradiation unit 32 act at a desired timing, and can make an infrared ray having a desired intensity incident on an inside of the work piece WP disposed on the second mold die 12 continuously or periodically.

The second heating unit 41 includes a heater 42 embedded in each of the first mold die 11 and the second mold die 12, and a driving circuit (not illustrated). The heater 42 gradually cools the softened glass body SG sandwiched between the transfer surfaces 15a and 16a during press molding by heating both the mold dies 11 and 12.

The temperature monitoring unit 51 includes a first sensor 52 for directly detecting the temperature of the work piece WP on the second mold die 12, a second sensor 53 for detecting the temperatures of the first mold die 11 and the second mold die 12, and a temperature monitoring driving unit 54 for making both the sensors 52 and 53 act. For example, the first sensor 52 is formed of a radiation thermometer to measure the temperature of the workpiece WP in a non-contact manner. For example, the second sensor 53 is formed of a thermocouple to measure the internal temperatures of the first mold die 11 and the second mold die 12. By using the first sensor 52, the chalcogenide glass work piece WP on the second mold die 12 can be accurately heated to a temperature equal to or higher than a softening point of the chalcogenide glass, for example, to a temperature approximately equal to or lower than a crystallization temperature thereof By using the second sensor 53, the temperatures of the transfer surfaces 15a and 16a of the mold dies 11 and 12 can be accurately heated in a range equal or lower than a temperature 10° C. lower than the temperature of the chalcogenide glass on the second mold die 12, and equal or higher than a temperature 50° C. lower than a glass transition temperature Tg of the chalcogenide glass.

The chamber 61 can control the atmosphere during heating and during press molding by accommodating the first mold die 11 and the second mold die 12.

The atmosphere adjustment unit 71 can supply a desired inert gas by reducing a pressure in the chamber 61, and can adjust the atmosphere around the work piece WP on the second mold die 12. This can make the atmosphere during heating of the work piece WP and during press molding thereof, for example, a nitrogen gas atmosphere, and can form a pressurized state higher than the atmospheric pressure. By controlling the atmosphere of the mold dies 11 and 12, component volatilization from the work piece WP or the softened glass body SG can be suppressed.

The main control unit 101 sets an action state of the production device 100 properly. The main control unit 101 can open or close the first mold die 11 and the second mold die 12 by making the mold die driving unit 21 act, can perform clamping by sandwiching the work piece WP (that is, softened glass body SG) softened on the second mold die 12 between the first mold die 11 and the second mold die 12 by lowering the first mold die 11, and can form a shape in which the upper and lower transfer surfaces 15a and 16a are inverted on the work piece WP or the softened glass body SG. The main control unit 101 controls action of the driving circuit of the second heating unit 41 or the heating driving unit 33 of the first heating unit 31 while measuring or monitoring the temperature of the work piece WP on the second mold die 12 and the temperatures of the first mold die 11 and the second mold die 12 by using the temperature monitoring unit 51. The main control unit 101 controls the atmosphere in the chamber 61 so as to be in an inert and pressurized state using the atmosphere adjustment unit 71.

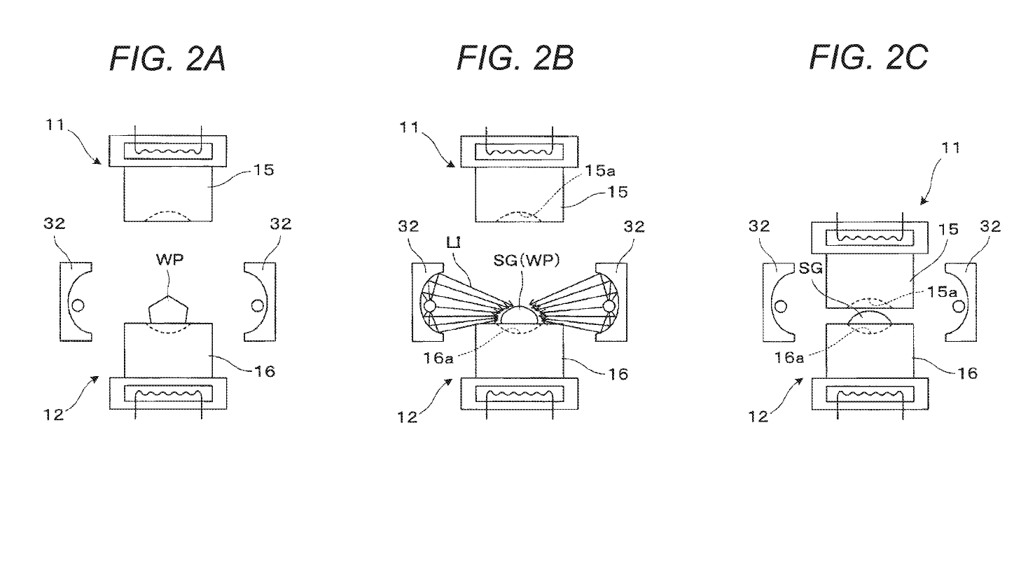

Hereinafter, a method for producing an optical element using the production device 100 in FIG. 1 will be described with reference to FIGS. 2A to 2C and the like.

As illustrated in FIG. 2A, the work piece WP is mounted on the second mold die 12 preheated to a temperature equal to or lower than a softening point. The work piece WP is formed of a glass material such as Ge—Se—Sb or As—Se, and is a small block obtained by cutting out only a necessary amount from a previously-formed large glass block (ingot). That is, a small portion obtained by dividing a large block into portions each having only a necessary weight substantially corresponding to a weight of a lens as an optical element to be produced is prepared in advance as the work piece WP. A necessary amount of fragments or pieces of the glass block collected may be used as the work piece WP. The workpiece WP can be preheated, for example, outside the chamber 61, before being mounted on the second mold die 12. The preheating temperature of the workpiece WP is lower than a glass transition temperature of chalcogenide glass. The work piece WP can be softened in a short time in main heating due to preheating. By setting the preheating temperature to a temperature lower than a glass transition temperature of chalcogenide glass, reduction in transmittance of chalcogenide glass can be prevented. An inside of the chamber 61 is an inert gas atmosphere such as N₂ in advance, and an internal pressure thereof is set so as to be the atmospheric pressure or higher. By heating chalcogenide glass by irradiation with the light LI including at least an infrared ray as described below and press molding in an inert gas atmosphere, oxidation of chalcogenide glass as a molding object can be suppressed, and reduction in transmittance can be prevented. In addition, by setting the internal pressure to an ambient pressure higher than the atmospheric pressure, an effect of volatilization can be further reduced.

Subsequently, as illustrated in FIG. 2B, the first heating unit 31 is made to act, the work piece WP on the second mold die 12 is irradiated with the light LI including an infrared ray and having a predetermined intensity for a predetermined time, and main heating is performed at a temperature equal to or higher than a softening point of chalcogenide glass forming the work piece WP. By this main heating, the solid work piece WP is softened and becomes the softened glass body SG. By heating chalcogenide glass to a temperature equal to or higher than a softening point thereof, a surface state of chalcogenide glass before molding can be a mirror surface regardless of an original surface state (for example, a rough surface). Therefore, only cutting out a small piece makes it possible to use the small piece as the work piece WP without special processing, waste of a material can be reduced, and processing time can be shortened. Furthermore, by heating the work piece WP on the mold die 12, transferability of a lower surface of the workpiece WP is improved, and therefore a complex shape is formed easily. A range of press conditions can be wide.

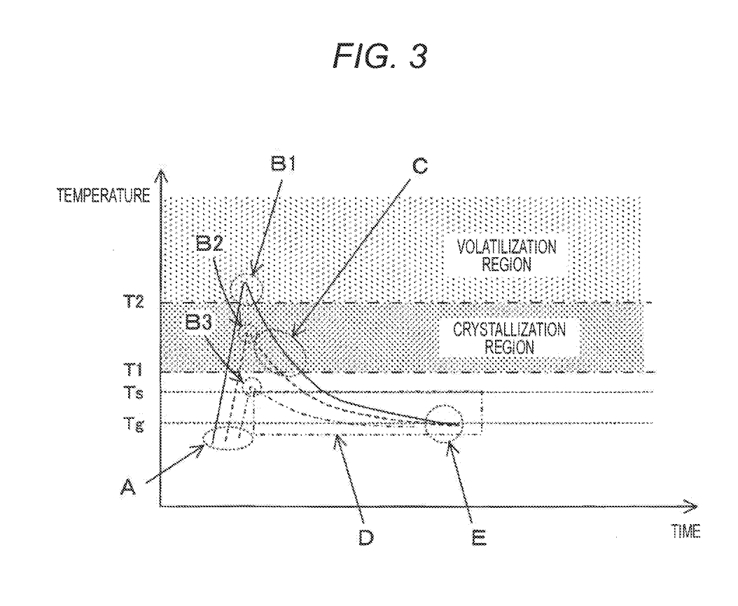

The temperature of main heating of the work piece WP is not particularly limited as long as being the softening point of chalcogenide glass Ts or higher. FIG. 3 schematically illustrates change in temperature from completion of preheating to molding through main heating. As illustrated in FIG. 3, heating is performed from a preheated state (refer to symbol A in FIG. 3) by irradiation with light in a short time (refer to symbols B1 to B3 in FIG. 3). In this case, at a higher temperature, glass can be formed into a mirror surface in a shorter time, but volatilization of a component occurs more easily. Therefore, preferably, the temperature is not much higher than an upper limit temperature in a crystallization temperature region (T1 to T2) as indicated by the solid line in FIG. 3 such that the temperature passes through the crystallization temperature region rapidly (refer to symbol C in FIG. 3) by lowering the temperature rapidly. For example, the temperature of main heating (refer to symbol B1 in FIG. 3) is up to the upper limit temperature in the crystallization temperature region T2+50° C. The temperature of main heating may be in the crystallization temperature region T1 to T2 (refer to the broken line and symbol B2 in FIG. 3). In this case, the time for forming the work piece WP into a mirror surface is slightly long, but a problem of volatilization of a component is prevented easily. The temperature of main heating may be equal to or higher than the softening point of chalcogenide glass Ts and less than the lower limit temperature T1 in the crystallization temperature region (refer to the one dot chain line and symbol B3 in FIG. 3). In this case, the time for forming a mirror surface is longer, but volatilization or crystallization can be prevented surely. In any case, in the present embodiment, heating is performed by irradiation with the light LI including an infrared ray for a predetermined time with the first heating unit 31 including the infrared lamp 32a. Therefore, the temperature can be raised or lowered in a short time. Therefore, a disadvantage caused by heating, such as volatilization, crystallization, or oxidation can be suppressed.

At the time of starting main heating, the temperature of the transfer member 16 of the second mold die 12 is set lower than a temperature for softening the workpiece WP, and fusion of the softened glass body SG of chalcogenide glass to the transfer surface 16a can be prevented. The temperature of the second mold die 12 is set so as to be equal to or lower than a temperature Ta of the softened glass body SG on the second mold die 12 −10° C. (preferably the temperature Ta −30° C. or lower), and equal to or higher than the glass transition temperature Tg of chalcogenide glass forming the softened glass body SG −50° C.

In this way, the solid glass work piece WP is heated to the softening point Ts or higher in a short time to be softened. When the work piece WP becomes the softened glass body SG in a form of a mirror surface, heating is completed, and the process proceeds to press molding with the first mold die 11. First, as illustrated in FIG. 2C, the heating action by the first heating unit 31 is stopped, or the setting is switched such that the die temperature is gradually lowered, and die closing is started by lowering the first mold die 11. By blocking at least a part of light with which the softened glass body SG is irradiated with a shield accompanying the first mold die 11 by lowering the first mold die 11 or gradually lowering the die temperature, the temperature of the glass may be lowered while the heating action by the first heating unit 31 is continued.

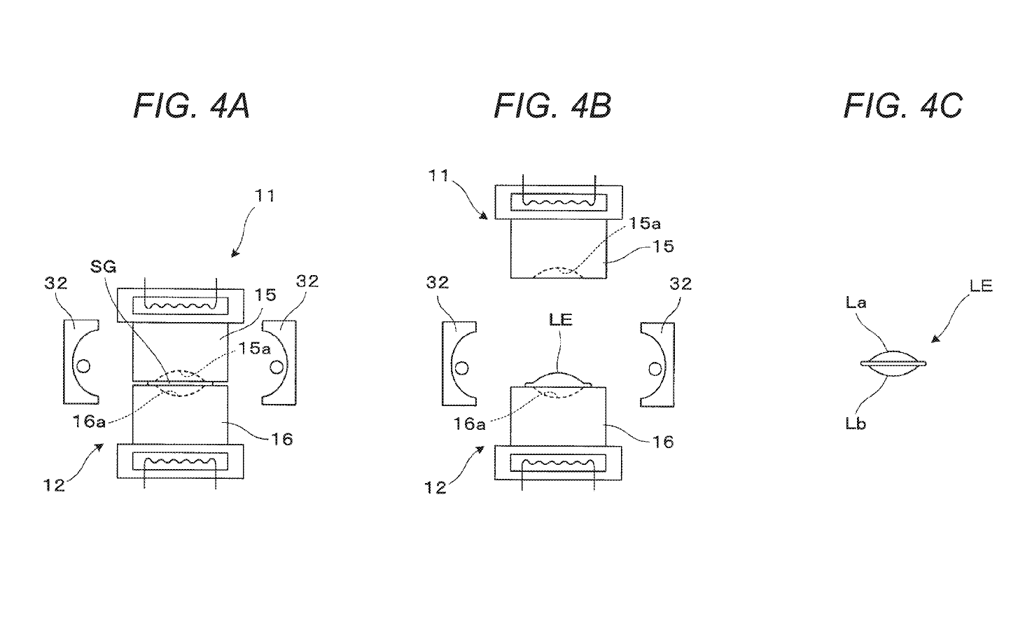

Subsequently, when the temperature becomes a temperature suitable for molding, that is, the temperature of chalcogenide glass lowers to a temperature equal to or lower than the softening point Ts, press molding is performed, and the temperature is lowered to the same temperature as that of the mold die while pressing is performed (refer to region D surrounded by the two dot chain line in FIG. 3). Specifically, as illustrated in FIG. 4A, clamping for pressing the first mold die 11 with respect to the second mold die 12 at a predetermined pressure is performed, and the softened glass body SG is subjected to press molding between the first mold die 11 and the second mold die 12. The temperature of each of the first mold die 11 and the second mold die 12 at the time of starting press molding of the softened glass body SG is set in a temperature range in which fusion does not occur easily and transferability is not deteriorated, that is, set so as to be equal to or lower than the temperature Ta of the softened glass body SG −10° C. (preferably the temperature Ta −30° C. or lower), and equal to or higher than the glass transition temperature Tg of the softened glass body SG −50° C. similarly to the time of softening. The softened glass body SG is cooled to the temperature of the mold die while being subjected to press molding. When the softened glass body SG is solidified, pressing is completed (refer to symbol E in FIG. 3). Before press molding of the softened glass body SG is terminated, the temperatures of the first mold die 11 and the second mold die 12 can be maintained, but can be lowered gradually.

Subsequently, as illustrated in FIG. 4B, the first mold die 11 is raised to be separated from the second mold die 12. As illustrated in FIG. 4C, a lens LE which is an optical element formed of solidified chalcogenide glass is released from the die to be extracted outside. The lens LE incudes optical surfaces La and Lb to which the transfer surfaces 15a and 16a of both the mold dies 11 and 12 have been transferred. As described above, by performing molding using the work piece WP having a necessary weight substantially corresponding to a weight of the lens LE as an optical element to be produced, it is possible to prevent an unnecessary amount of glass from being consumed, and to make postprocessing unnecessary.

In the production method according to the present embodiment, by heating chalcogenide glass with an infrared ray (light LI), an inside of the chalcogenide glass can be also heated uniformly. Therefore, the molded lens LE hardly causes a crack or the like, the work piece WP as a block of the chalcogenide glass can be softened in a short time, and time required for molding can be shortened. In addition, direct heating with an infrared ray (light LI) allows heating and cooling to be performed in a short time. Therefore, an effect of volatilization, oxidation, crystallization, or the like can be reduced, and the lens LE having a high transmittance can be molded. Press molding can be performed while the temperature of the second mold die 12 is lower than that of the glass. Therefore, the lens LE hardly causing fusion and having an excellent appearance can be molded with a low maintenance frequency. The temperature of the glass can be controlled separately from that of the second mold die 12. Therefore, the lens LE having a higher surface accuracy or shape accuracy can be produced.

### Second Embodiment

Hereinafter, a production method according to a second embodiment will be described. The production method according to the second embodiment is obtained by partially modifying the production method according to the first embodiment. Matters not particularly described are similar to those in the production method according to the first embodiment.

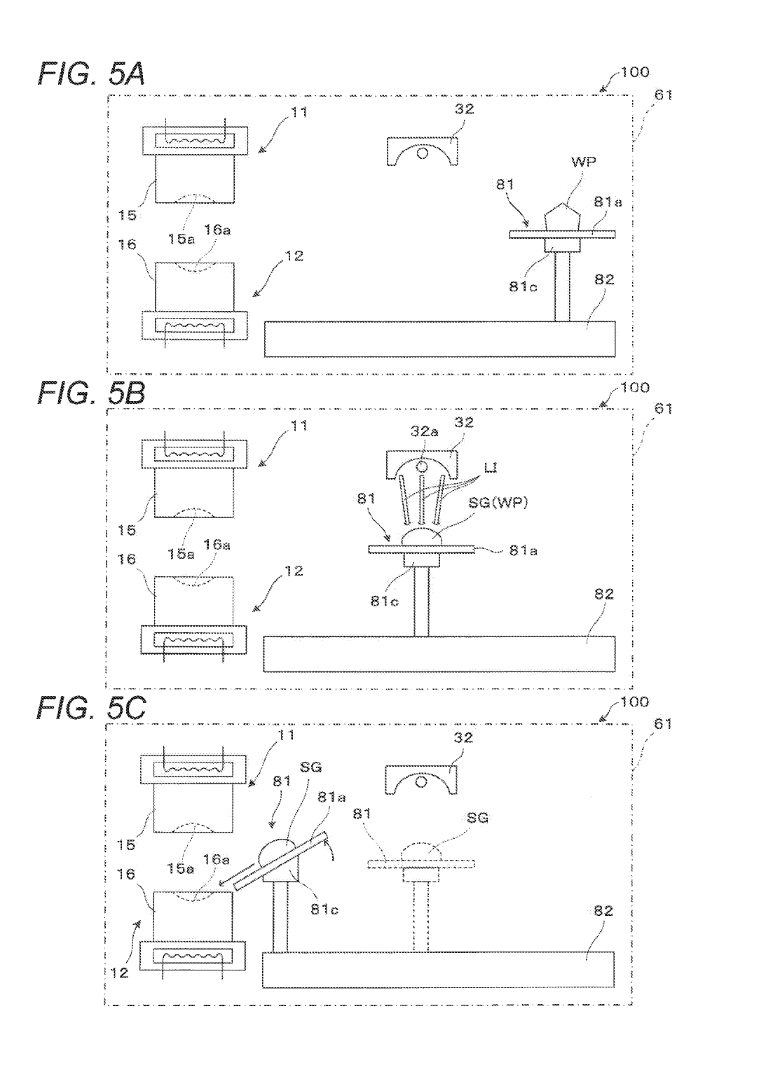

A production device 100 illustrated in FIG. 5A includes a stage 81 for supporting a work piece WP and a driving unit 82 for moving the stage 81. The driving unit 82 can dispose the stage 81 at a position for delivering the work piece WP, a heating and softening position immediately below an infrared ray irradiation unit 32, and a transfer position for transferring the work piece WP to a second mold die 12. The one production device 100 can include a plurality of the stages 81, a plurality of the delivering positions, and a plurality of the heating and softening positions.

The stage 81 includes a flat plate-shaped support plate 81a, and can incline the support plate 81a appropriately with a movable unit 81c. The support plate 81a is formed of a material having a low thermal conductivity, preferably a thermal conductivity of less than 20 W/mK, more preferably a thermal conductivity of less than 10 W/mK (for example, zirconia or glassy carbon). This can prevent heat from being taken away from the work piece WP during heating described below, and allows the work piece WP to be heated uniformly in a short time. By isolating a function as a support stand for heating, a range for selecting a die material which can be used for a mold die can be widened. By performing heating and molding in parallel, molding tact can be shortened, and the number of molding or the mold die can be reduced. By coating a surface of the support plate 81a with a material having a low emissivity, heating of the support plate 81a can be suppressed.

Hereinafter, the method for producing an optical element according to the second embodiment will be described with reference to FIGS. 5A to 5C and the like.

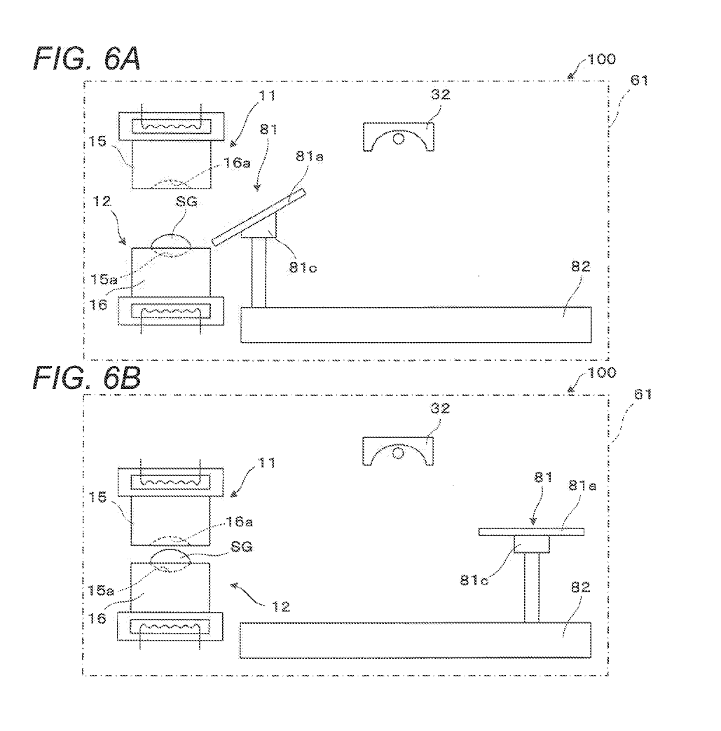

First, the stage 81 is moved to the delivering position near an inlet of a chamber 61, and the work piece WP is received by the support plate 81a (refer to FIG. 5A). Subsequently, the stage 81 is moved to the heating and softening position outside the mold die, and the work piece WP on the support plate 81a is softened by main heating utilizing direct irradiation with an infrared ray (light LI) from the infrared ray irradiation unit 32 to obtain the softened glass body SG (refer to FIG. 5B). Subsequently, the stage 81 is moved to the transferring position and is inclined (refer to FIG. 5C), and the softened glass body SG on the support plate 81a is thereby supplied to a die mounted on the second mold die 12 (refer to FIG. 6A). Subsequently, clamping for pressing the first mold die 11 with respect to the second mold die 12 is performed by lowering the first mold die 11, and the softened glass body SG is subjected to press molding while being sandwiched between the transfer members 15 and 16 of both the mold dies 11 and 12 (refer to FIG. 6B). Thereafter, (not illustrated) after the softened glass body SG between the first mold die 11 and the second mold die 12 is solidified, the softened glass body SG is separated from the first mold die 11 and the second mold die 12. A lens LE formed of the solidified and hardened chalcogenide glass can be thereby extracted from the dies. This lens LE is conveyed to the outside from an outlet of the chamber 61. The temperature for softening the work piece WP or press molding thereof is similar to that in the first embodiment.

Hereinafter, results of a comparative experiment for confirming an effect of the embodiments will be described. Chalcogenide glass having a composition of Ge _{15 to 20}, Sb _{15 to 20}, and Se _{60 to 70}, a glass transition temperature of 320° C., and a softening point of 360° C. was used. A disc-like workpiece having a diameter of 20 mm and a thickness of 3 mm was cut out from an ingot of chalcogenide glass having this composition using a diamond cutter. This workpiece was placed on a glassy carbon plate and was preheated up to 300° C. Thereafter, chalcogenide glass as the workpiece was heated to a predetermined temperature in a range of 360 to 500° C. with a halogen lamp heater having an output of 1000 W. After heating, the chalcogenide glass was transferred onto a mold die at a predetermined temperature in a range of 300 to 360° C. The chalcogenide glass was pressed for 60 seconds under a load of 0.29 kN. Then, a biconvex aspheric lens having an optical surface effective diameter of 17.9 mm, a sag amount of a first surface of 0.535 mm, and a sag amount of a second surface of 0.842 mm was molded.

Preheating, heating by light including an infrared ray, and molding were performed in a N₂ atmosphere at 1 or 2 atm. After pressing, the load was released. The molded article was released from the die, was transferred to a slow cooling stand at 300° C., and was cooled to room temperature over about 10 minutes. A surface accuracy, a surface roughness, and a transmittance of the molded article obtained by mold-releasing were measured. The surface accuracy was measured with a three-dimensional measuring machine. The surface roughness was measured using a white light interferometer. An intensity of light in a range of 8 to 14 μm was measured using FT-IR in a case where white light passed through a lens and in a case where white light did not pass through a lens. The transmittance was calculated as a ratio of the former case with respect to the latter case. In the surface accuracy, a case in which an amount deviated from a set value was 0.2 μm or less was represented by a symbol ∘, and a case in which the deviation amount was more than 0.2 μm was represented by a symbol ×. In the surface roughness, a case in which no fusion occurred and Ra was 15 nm or less was represented by a symbol ∘, and a case in which fusion occurred or Ra was more than 15 nm was represented by a symbol ×. Table 1 shows molding results under conditions.

TABLE 1

| | Glass heating | Temperature of | | Press | | | | |
|---|---|---|---|---|---|---|---|---|
| | temperature | mold die | Press load | time | Air | Surface | Surface | Transmittance |
| No. | (° C.) | (° C.) | (kN) | (sec) | pressure | accuracy | roughness | 8 to 14 μm |
| 1 | 360 | 340 | 0.29 | 60 | 1 | ◯ | ◯ | 60% or more |
| 2 | 360 | 320 | 0.29 | 60 | 1 | ◯ | ◯ | 60% or more |
| 3 | 360 | 300 | 0.29 | 60 | 1 | ◯ | ◯ | 60% or more |
| 4 | 390 | 310 | 0.29 | 60 | 1 | ◯ | ◯ | 60% or more |
| 5 | 420 | 310 | 0.29 | 60 | 1 | ◯ | ◯ | 60% or more |
| 6 | 500 | 310 | 0.29 | 60 | 2 | ◯ | ◯ | 60% or more |
| 7 | 360 | 360 | 0.29 | 60 | 1 | — | X | 40% or less |

In First to Sixth Experiment Examples in which a temperature of a mold die was lower than a glass heating temperature, an optical element having an excellent surface accuracy, surface roughness, and transmittance was obtained. Meanwhile, in Seventh Experiment Example in which the glass heating temperature was the same as the temperature of a mold die, fusion occurred, and a surface accuracy could not be evaluated.

In the above description, the present invention has been described with reference to the embodiments, but the present invention is not limited to the above embodiments, but various modifications can be performed. For example, the composition of chalcogenide glass is not limited to those exemplified above, but a method similar to the above method can be applied to chalcogenide glass having various compositions.

In the above embodiments, an optical element other than the lens LE can be obtained by adapting the shape of each of the transfer surfaces 15a and 16a to a purpose.

In the above embodiments, the infrared ray irradiation unit 32 is not limited to a combination of the infrared lamp 32a and the mirror 32b, but various light sources capable of local irradiation with heating light such as an infrared ray can be used.

1. A method for producing an optical element comprising:
softening chalcogenide glass by heating the chalcogenide glass by irradiating the chalcogenide glass with light including an infrared ray; and
subjecting the softened chalcogenide glass to press molding with a mold die at a lower temperature than that of the chalcogenide glass.

2. The method for producing an optical element according to claim 1, comprising:
softening the chalcogenide glass by heating the chalcogenide glass to a temperature equal to or higher than a softening point of the chalcogenide glass by irradiation with the light including an infrared ray.

3. The method for producing an optical element according to claim 1, comprising:
heating the chalcogenide glass mounted on a member formed of a material having a thermal conductivity of 20 W/mK or less by irradiating the chalcogenide glass with the light including an infrared ray.

4. The method for producing an optical element according to claim 1, comprising:
irradiating the chalcogenide glass with the light including an infrared ray using an infrared ray lamp having an energy distribution in a wavelength of 0.5 μtm to 2 μm.

5. The method for producing an optical element according to claim 1, comprising:
preheating the chalcogenide glass to a temperature lower than a glass transition temperature thereof; and then
heating the chalcogenide glass by irradiating the chalcogenide glass with the light including an infrared ray.

6. The method for producing an optical element according to claim 1, comprising:
performing at least heating of the chalcogenide glass by irradiation with the light including an infrared ray and press molding in an inert gas atmosphere.

7. The method for producing an optical element according to claim 1, comprising:
softening the chalcogenide glass having a necessary weight substantially corresponding to a weight of an optical element to be produced.

8. The method for producing an optical element according to claim 1, wherein the temperature of the mold die at the time of starting press molding of the chalcogenide glass is equal to or lower than a temperature 10° C. lower than the temperature of the chalcogenide glass on the mold die and equal to or higher than a temperature 50° C. lower than the glass transition temperature of the chalcogenide glass.

9. The method for producing an optical element according to claim 1, comprising:
heating the chalcogenide glass mounted on the mold die by irradiating the chalcogenide glass with the light including an infrared ray.

10. The method for producing an optical element according to claim 1, wherein a surface of the mold die is formed of a material having an emissivity of 0.3 or less.

11. The method for producing an optical element according to claim 1, comprising:
softening the chalcogenide glass by heating the chalcogenide glass by irradiating the chalcogenide glass with the light including an infrared ray outside the mold die; and then
supplying the softened chalcogenide glass to the mold die.

12. The method for producing an optical element according to claim 1, comprising:
softening the chalcogenide glass by heating the chalcogenide glass by irradiation with the light including an infrared ray in a pressurized atmosphere higher than the atmospheric pressure.

13. The method for producing an optical element according to claim 3, comprising:
preheating the chalcogenide glass to a temperature lower than a glass transition temperature thereof; and then
heating the chalcogenide glass by irradiating the chalcogenide glass with the light including an infrared ray.

14. The method for producing an optical element according to claim 2, comprising:
heating the chalcogenide glass mounted on a member formed of a material having a thermal conductivity of 20 W/mK or less by irradiating the chalcogenide glass with the light including an infrared ray.

15. The method for producing an optical element according to claim 2, comprising:
irradiating the chalcogenide glass with the light including an infrared ray using an infrared ray lamp having an energy distribution in a wavelength of 0.5 μm to 2 μm.

16. The method for producing an optical element according to claim 2, comprising:
preheating the chalcogenide glass to a temperature lower than a glass transition temperature thereof; and then
heating the chalcogenide glass by irradiating the chalcogenide glass with the light including an infrared ray.

17. The method for producing an optical element according to claim 2, comprising:
performing at least heating of the chalcogenide glass by irradiation with the light including an infrared ray and press molding in an inert gas atmosphere.

18. The method for producing an optical element according to claim 2, comprising:
softening the chalcogenide glass having a necessary weight substantially corresponding to a weight of an optical element to be produced.

19. The method for producing an optical element according to claim 2, wherein the temperature of the mold die at the time of starting press molding of the chalcogenide glass is equal to or lower than a temperature 10° C. lower than the temperature of the chalcogenide glass on the mold die and equal to or higher than a temperature 50° C. lower than the glass transition temperature of the chalcogenide glass.

20. The method for producing an optical element according to claim 2, comprising:
heating the chalcogenide glass mounted on the mold die by irradiating the chalcogenide glass with the light including an infrared ray.
